(19) United States
(12) Patent Application Publication
(10) Pub. No.: US 2006/0103171 A1
(43) Pub. Date: May 18, 2006

(54) Acoustically effective underbody covering for motor vehicles

(76) Inventors: Heinz Blomeling, Leichlingen (DE); Volkmar Abeck, Koln (DE)

Correspondence Address: WILLIAM COLLARD;COLLARD & ROE, P.C., 1077 NORTHERN BOULEVARD, ROSLYN, NY, 11576, US

(21) Appl. No.: 10/534,080

(22) PCT Filed: Sep. 23, 2004
(86) PCT No.: PCT/EP04/10663

§ 371 Date: May 6, 2005

(30) Foreign Application Priority Data
Oct. 23, 2003 (DE) 103 49 743.9

(51) Int. Cl. B62D 25/20

(52) U.S. Cl. 296/204

(57) ABSTRACT

The present invention relates to an underbody covering (1′) for motor vehicles, having a support part (2′) attachable to the underbody (12) of the motor vehicle and at least one sound-absorbing part (3) supported thereby. In order, to achieve improved sound insulation, to be able to cover even parts of an exhaust train (13) and/or other parts emitting a high temperature radiation on the bottom of a vehicle floor part (12) using such an underbody covering, it is provided according to the present invention that the sound-absorbing part (3) is at least partially covered on top with a microperforated, heat-shielding layer (14), the microperforated, heat-shielding layer (14) being exposed toward the underbody (12) of the motor vehicle and the sound-absorbing part (3) being made of mineral wool, an open-pored foam, and/or a fibrous nonwoven material.

The present invention relates to an acoustically effective underbody covering for motor vehicles, having a support part attachable to the underbody of a motor vehicle, and at least one sound-absorbing part supported thereby.

An underbody covering of a motor vehicle, which has a double-walled construction having a bottom wall and a top wall, the bottom wall forming an underside adapted to the flow, which covers the floor of the motor vehicle, is known from EP 1 251 062 A2. A sound absorber is integrated into the underbody covering in such a way that the bottom wall and/or the top wall is/are implemented as a structured part, the structured part having hollow chambers like small boxes that act as resonator elements. The hollow chambers are connected to one another in this case and are therefore part of a shared air volume. The underbody covering is manufactured as an extrusion blow-molded part.

DE 100 01 932 A1 discloses a covering element which is used as an underbody cover plate for a motor vehicle to shield the engine and parts of the exhaust system from sound emissions. The covering element, which is simultaneously used to improve the drag coefficient of a motor vehicle, is manufactured from thermoplastic and is implemented as a self-supporting rigid hollow body, which at least partially contains a sound-absorbing filling made of foamed thermoplastic.

A sound insulator, which is positioned on the bottom of a floor part of a vehicle and is positioned within lateral longitudinal beams of the vehicle structure, is described in DE 44 12 427 C2. The sound insulator has a perforated plate which is at a distance to the bottom of the vehicle floor part, an air space being formed between the perforated plate and the bottom of the vehicle floor part. In some of the described embodiments of this sound insulator, the air space is partially or completely filled with porous, sound-absorbing material.

The present invention is based on the object of providing an acoustically effective underbody covering for motor vehicles, using which even parts of an exhaust train and/or other parts emitting a high-temperature radiation on the bottom of a vehicle floor part may be covered in such a way that improved sound insulation is achieved in particular.

This object is achieved in an underbody covering of the above-mentioned type according to the present invention in that the sound-absorbing part is at least partially covered on top with a microperforated, heat-shielding layer, the microperforated, heat-shielding layer being exposed toward the underbody of the motor vehicle and the sound-absorbing part being produced from mineral wool, an open-pored foam, and/or a fibrous nonwoven material, particularly a needle-punched nonwoven.

Covering the top of the sound-absorbing part with a microperforated, heat-shielding layer even allows the sound-absorbing part of the underbody covering to be positioned below an exhaust train and/or other parts emitting a high thermal radiation. The underbody covering according to the present invention therefore particularly allows encapsulation of the exhaust train, which results in a significant improvement of the sound insulation on the relevant motor vehicle. Simultaneously, through the shielding of exhaust parts and/or other hot parts on the bottom of the vehicle floor connected therewith, a fire hazard, which arises in a typical motor vehicle if it is parked at a location at which dry grass or another easily flammable material is present below the vehicle, is counteracted.

A preferred embodiment of the underbody covering according to the present invention is characterized in that the sound-absorbing part and the microperforated, heat-shielding layer are positioned at a distance to one another. The air layer defined in this way is advantageous both in regard to the thermal insulation effect and in regard to the acoustic insulation effect.

For a high sound-insulating effect of the underbody covering, it is favorable if the support part is equipped with one relatively large and/or multiple separate sound-absorbing part(s). The combination of the sound-absorbing part and/or corresponding separate parts with one or more microperforated, heat-shielding layers may be limited in this case to the region of the underbody covering which lies in proximity to the exhaust train and/or other parts having a relatively high temperature. Accordingly, a further preferred embodiment of the underbody covering according to the present invention is characterized in that at least one further sound-absorbing part, whose top is exposed, is supported on the support part.

In order to achieve an especially high sound-insulating effect, the support part of the underbody covering according to the present invention may be designed according to a further preferred embodiment in such a way that it forms an essentially closed cavity with the underbody of the motor vehicle in the mounted state.

According to a further preferred embodiment of the present invention, the sound-absorbing part is permeable to air. This embodiment allows an air exchange in the cavity defined by the vehicle underbody and the underbody covering, so that heat transfer may be ensured through convection in regard to the exhaust train located in the cavity or other hot parts located therein.

A further advantageous embodiment of the underbody covering according to the present invention is that at least one opening is implemented on the support part, which is used for cooling airflow against an exhaust train section or another vehicle assembly that releases heat. In this case, at least one air channel may preferably also be implemented on the support part, via which cooling air may be purposefully supplied to an exhaust train section or vehicle assembly to be cooled.

In a further embodiment, the bottom of the support part of the underbody covering according to the present invention is implemented largely or as a whole with a smooth surface in order to reduce the flow resistance (drag coefficient) of the relevant motor vehicle and therefore its fuel consumption. It is also favorable in regard to reducing the flow resistance if the sound-absorbing part(s) is/are covered on the bottom with a perforated film. For example, a perforated or microperforated smooth plastic film made of polypropylene may be used as the perforated film. The smooth, microperforated film may not only reduce the flow resistance of the relevant motor vehicle, but rather additionally acts as a moisture barrier, so that the sound-absorbing parts of the underbody covering do not lose their acoustic activity through the penetration of sprayed water. In addition or alternatively, the sound-absorbing parts may be equipped to be hydrophobic and/or oleophobic.

Further preferred and advantageous embodiments of the underbody covering according to the present invention are specified in the subclaims.

In the following, the present invention will be explained in greater detail on the basis of a drawing showing multiple exemplary embodiments.

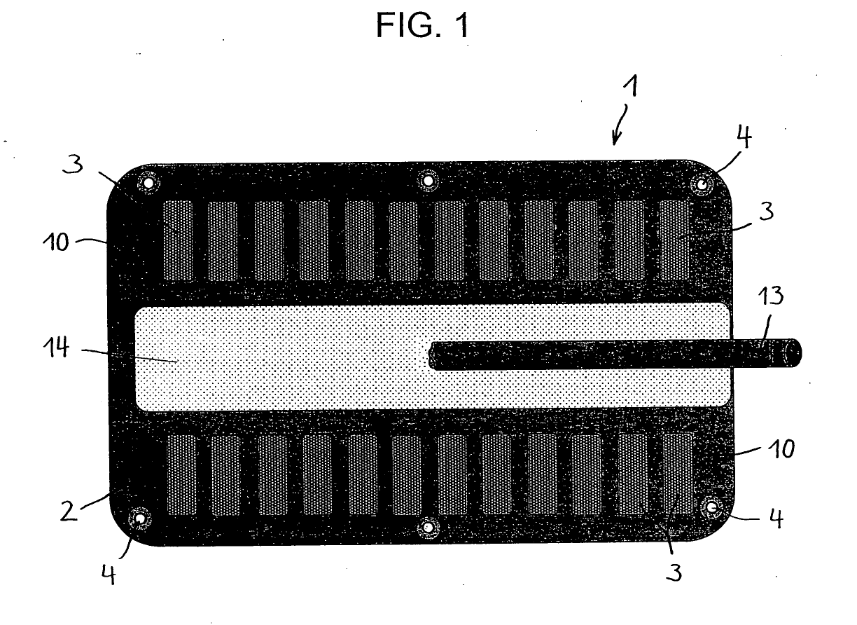

FIG. 1 schematically shows a top view of an underbody covering according to a first exemplary embodiment of the present invention;

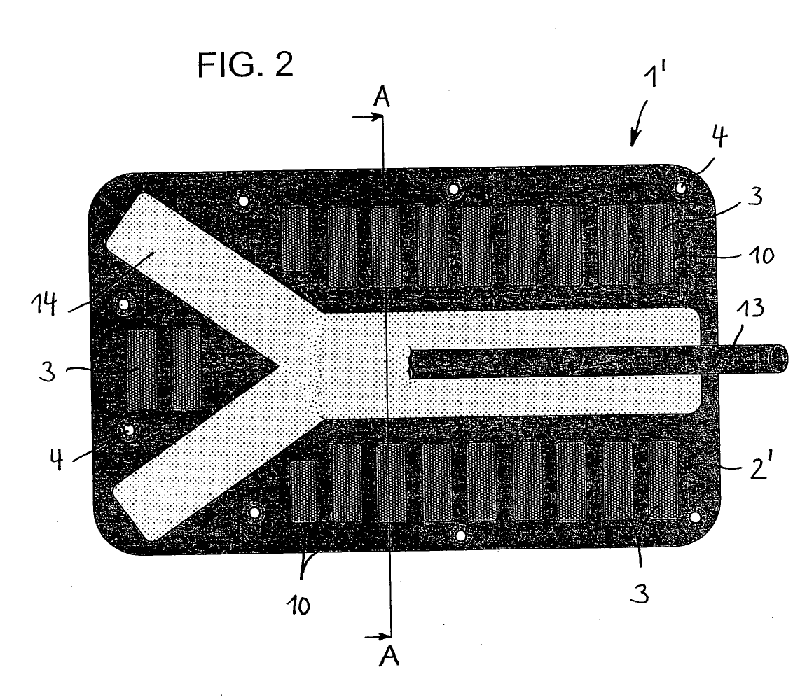

FIG. 2 schematically shows a top view of an underbody covering according to a second exemplary embodiment of the present invention;

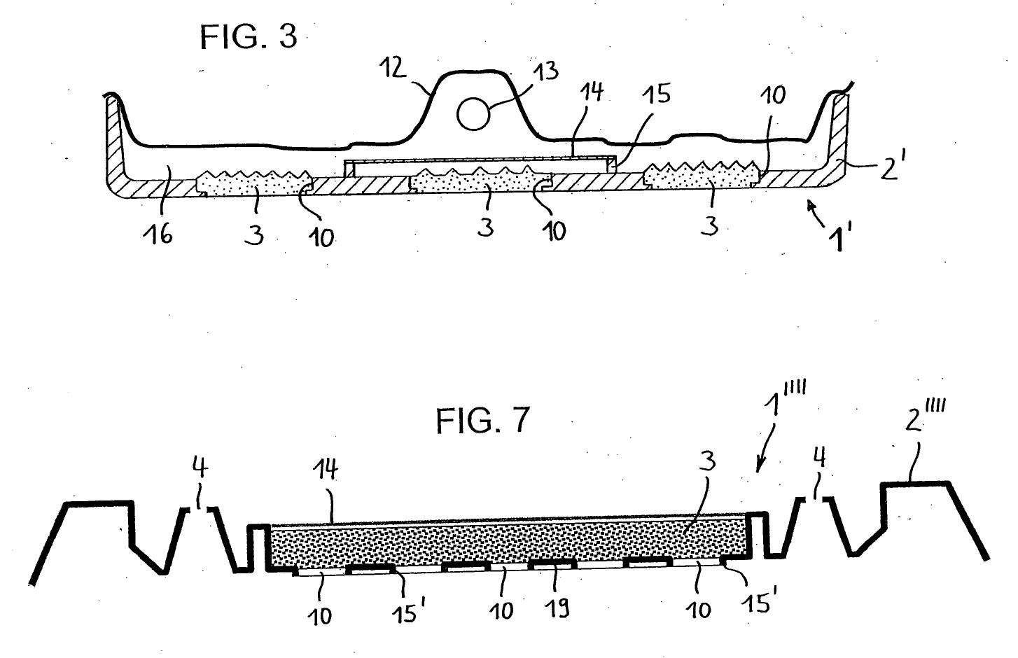

FIG. 3 schematically shows a sectional view of the underbody covering shown in FIG. 2 along the section line A-A;

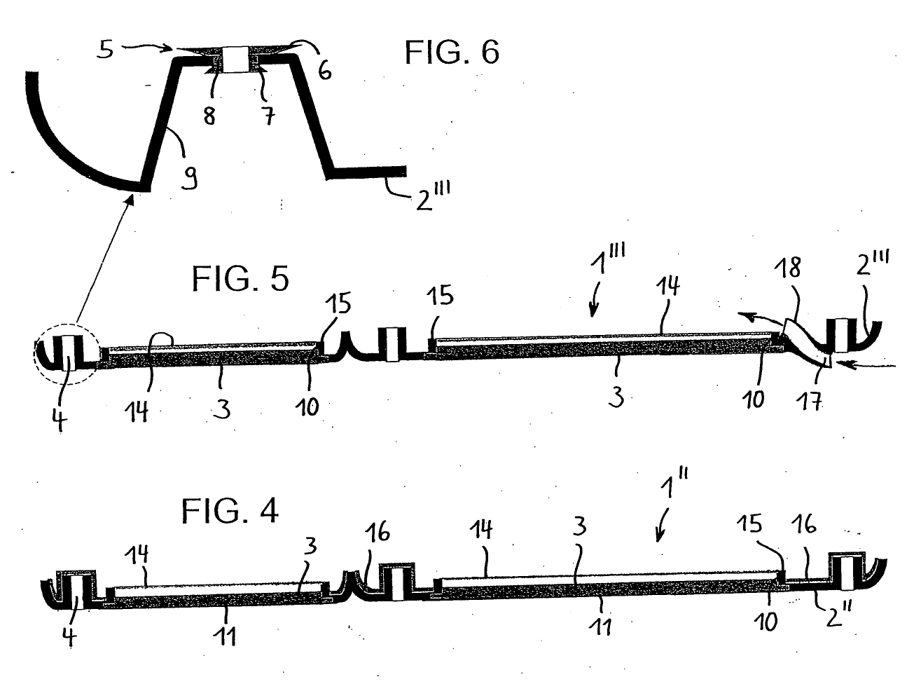

FIG. 4 schematically shows a sectional view of an underbody covering according to a third exemplary embodiment of the present invention;

FIG. 5 schematically shows a sectional view of an underbody covering according to a fourth exemplary embodiment of the present invention;

FIG. 6 schematically shows an enlarged detail illustration of an oscillation-decoupling element in a sectional view; and

FIG. 7 schematically shows a sectional view of an underbody covering according to a fifth exemplary embodiment of the present invention.

The underbody coverings 1, 1′, 1″, 1′″, 1″″ shown in the drawing are constructed from a support part 2, 2′, 2″, 2′″, 2″″ and one or more sound-absorbing parts 3 supported by the support part. Multiple bore holes and/or corresponding recesses 4 are implemented in the support part 2, 2′, 2″, 2′″, 2″″, which are used for passing through fastening means connectable to the underbody of the motor vehicle, particularly fastener screws or lockable plug-in connectors (not shown).

The recesses and/or bore holes 4 are provided with oscillation-decoupling elements, via which the support part 2, 2′, 2″, 2′″, 2″″ is attachable to the underbody of the motor vehicle. The oscillation-decoupling elements may be implemented in the form of rubber sleeves, for example, which are connected in a form-fitting way to the support part. The rubber sleeve 5 shown in FIG. 6 has two flange-like sections 6, 7, which are implemented in one piece with a central section 8 having a reduced diameter. The bore hole and/or recess 4 to receive the rubber sleeve 5 is positioned on a cup-shaped depression 9, which receives the head of a fastener screw (not shown) and may be closed flush to the bottom of the support part 2′ by a cap (not shown) or the like.

The support part 2, 2′, 2″, 2′″, 2″″ is manufactured from plastic, preferably from fiberglass-reinforced polypropylene. The glass fibers mixed with the plastic have an average length of approximately 30 mm. Their proportion in the support part is preferably approximately 30 weight-percent. The bottom of the support part 2, 2′, 2″, 2′″, 2″″ is implemented largely or as a whole with a smooth surface, so that the drag coefficient of the vehicle equipped with the underbody covering is relatively low. The support part 2, 2′, 2″, 2′″, 2″″ may be manufactured in the injection molding method or in the molten-layer deposition compression molding method.

The support parts 2, 2, 2′, 2″, 2″′ illustrated in FIGS. 1 through 5 each have multiple recesses and/or passages 10, in each of which a sound-absorbing part 3 is set. The sound-absorbing parts 3 are supported or clamped around the edge in the step-shaped recesses and/or passages 10 of the support part. The sound-absorbing parts 3 may be laid in a mold during manufacturing of the support part 2, 2′, 2″, 2″′ and extrusion coated and/or compressed around the edge with the fiberglass-reinforced plastic of the support part 2, 2′, 2″, 2″′.

The sound-absorbing parts 3 are each produced from an air-permeable and/or open-pored material layer which has a thickness of 10 to 30 mm, for example. They are preferably produced from an open-pored foam, particularly an ether foam or melamine resin foam, and/or a fibrous nonwoven material, particularly a polyester fiber nonwoven. Alternatively or additionally, the sound-absorbing parts may also comprise mineral wool, particularly mineral fiber nonwoven. The sound-absorbing parts may particularly be implemented as multilayered. For example, they may be constructed from one or more foam layers and/or one or more nonwoven layers, particularly needle-punched nonwoven layers. In order to prevent the absorption of moisture, which could impair the acoustic efficacy, the foam and/or fibrous nonwoven material is preferably finished to be hydrophobic and/or oleophobic.

In the exemplary embodiment illustrated in FIG. 4, the bottoms of the sound-absorbing parts 3 are each covered with a microperforated plastic film 11 that is externally exposed. The plastic film 11 acts as a moisture barrier in spite of its perforation, since the perforation is a microperforation having relatively small hole diameters. Furthermore, the plastic film 11, which is also acoustically effective, contributes to reducing the drag coefficient.

The side of the sound-absorbing parts 3 facing toward the bottom of the vehicle floor sheet metal 12 may be implemented as flat, but is preferably also profiled in order to increase the acoustically effective surface and therefore the sound absorbing capability (cf. FIG. 3).

The subdivision of the sound-absorbing material 3 by multiple passages 10 of the support part 2, 2′, 2″, 2″′ is more favorable in regard to the dimensional stability of the support part 2, 2′, 2″, 2″′ than an embodiment having only one single, relatively large passage 10, for example.

The passages 10 are positioned uniformly in the exemplary embodiments shown here. They may particularly be positioned distributed in a raster, as shown in FIGS. 1 and 2. However, it is also possible to position the sound-absorbing parts 3 and accordingly the associated recesses and/or passages 10 irregularly on the particular support part 2 and/or implement their areas with different dimensions.

A section of an exhaust train 13 is schematically indicated in each of FIGS. 1 through 3. In the region of the underbody covering 1 which faces toward hot vehicle parts such as the exhaust train 13, particularly an exhaust catalytic converter, the sound-absorbing parts 3 are covered on top with at least one microperforated, heat-shielding layer 14 that is exposed toward the underbody 12 of the motor vehicle. The heat-shielding layer 14 preferably comprises a microperforated aluminum film. It may have a thickness from 0.1 to 0.3 mm, for example.

The heat-shielding layer 14 is positioned at a distance to the respective sound-absorbing part 3, a peripheral rib 15 that projects upward, onto which the layer 14 is welded or glued, being implemented on the underbody covering 1. However, embodiments in which the microperforated, heat-shielding layer 14 is clamped, cast in, or extrusion coated around the edge on the support part 2 also lie in the scope of the present invention. The heat-shielding layer 14 is then integrated in one piece into the support part 2. Through a connection of support part 2 and heat-shielding layer 14 of this type, at least one work step may be saved during the manufacture of the underbody covering.

The spacing between the microperforated heat protection layer 14 and the sound-absorbing part 3 may be approximately 10 mm, for example. The microperforated heat protection layer 14 and the assigned sound-absorbing part 3 thus define an air chamber.

Using the underbody covering 1 shown in FIG. 1, an exhaust train section 13 implemented essentially linearly may be covered. In contrast, the underbody covering 1′ shown in FIG. 2 is intended for the purpose of covering an exhaust train section 13 having a branch. The heat-shielding layer 14 is correspondingly implemented as Y-shaped, multiple sound-absorbing parts being positioned in the support 2′ below the layer 14.

The tops of the sound-absorbing parts 3 positioned further away from the exhaust train 13 and closer to the longitudinal spars of the motor vehicle are not covered by a microperforated, heat-shielding layer 14, but rather are exposed.

The support part 2, 2′, 2″, 2′″, 2″″ is shaped in such a way that the microperforated, heat-shielding layer 14 and the sound-absorbing parts 3, whose top is exposed, are each at a distance to the underbody 12 of the motor vehicle in the mounted state of the underbody covering 1, 1′, 1″, 1′″, 1″″. In this case, the support part 2 forms an essentially closed cavity 16 with the underbody 12 of the motor vehicle.

As shown in FIGS. 4 and 5, the peripheral ribs 15, onto which the microperforated aluminum film 14 is glued or welded using ultrasound, may particularly also be implemented on the edge of the particular passage 10.

In the exemplary embodiment according to FIG. 4, the inside of the support part 2″ is particularly provided with an oscillation-decoupling coating 16 in the region of the attachment points. The oscillation-decoupling coating 16 may be applied over the entire area of the inside of the support part 2″, with the exception of the regions of the passages having the sound-absorbing parts 3.

In the exemplary embodiment according to FIG. 5, at least one opening 17 having a short air channel 18 is implemented on the carrier part 2′″, which is used for cooling airflow against an exhaust train section or another heat-releasing vehicle assembly. If necessary, a longer air channel (not shown) may adjoin the opening 17, which is connected as a separate part to the support part 2″ or is implemented in one piece with the support part.

The underbody covering 1″″ shown in FIG. 7 has a support part 2″″ having a depression, into which a sound-absorbing part 3 is laid. The sound-absorbing part 3 is in turn covered on top with a microperforated aluminum film 14 that is connected around the edge to the support part 2″″. The aluminum film 14 is positioned at a distance to the sound-forming part 3 in this case, so that an air layer lies between them. Multiple recesses or passages 10 are implemented in the floor 19 of the depression. A peripheral rib 15′ that projects downward is provided on the edge of the particular passage 10. The ribs 15′ are acoustically effective. These are resonance ribs in this case. In addition, these ribs contribute to the dimensional stability of the support part 2″″.

1. An acoustically effective underbody covering (1, 1′, 1″, 1′″, 1″″) for motor vehicles, having a support part (2, 2′, 2″, 2′″, 2″″) attachable to the underbody (12) of the motor vehicle and at least one sound-absorbing part (3) supported thereby, wherein the sound-absorbing part (3) is at least partially covered on top with a microperforated, heat-shielding layer (14), the microperforated, heat-shielding layer (14) being exposed toward the underbody (12) of the motor vehicle and the sound-absorbing part (3) being made of mineral wool, an open-pored foam, and/or a fibrous nonwoven material.

2. The underbody covering according to claim 1, wherein the sound-absorbing part (3) and the microperforated, heat-shielding layer (14) are positioned at a distance to one another.

3. The underbody covering according to claim 1 wherein at least one further sound-absorbing part (3), whose top is exposed, is supported on the support part (2, 2′, 2″, 2′″, 2″″).

4. The underbody covering according to claim 1, wherein the sound-absorbing part (3) is clamped and/or supported in a form-fitting way around its edge on the support part (2, 2′, 2″, 2′″, 2″″).

5. The underbody covering according to claim 1, wherein the sound-absorbing part (3) is permeable to air.

6. The underbody covering according to claim 1, wherein the sound-absorbing part (3) is formed by one or more air-permeable and/or open-pored material layers.

7. The underbody covering according to claim 1, wherein the bottom of the support part (2, 2′, 2″, 2′″, 2″″) is implemented largely or as a whole with a smooth surface.

8. The underbody covering according to claim 1, wherein the sound-absorbing part (3) is covered on the bottom with a perforated film which is externally exposed.

9. The underbody covering according to claim 1, wherein the sound-absorbing part (3) is set in a passage implemented in the support part.

10. The underbody covering according to claim 9, wherein a peripheral rib (15, 15′), which projects upward and/or downward, is implemented on the edge of the passage (10).

11. The underbody covering according to claim 1, wherein multiple passages (10) are implemented in the support part (2, 2′, 2″, 2′″, 2″″), in each of which a sound-absorbing part is set.

12. The underbody covering according to claim 1, wherein the support part (2, 2′, 2″, 2′″, 2″″) has oscillation-decoupling elements (5), via which the support part is attachable to the underbody of the motor vehicle.

13. The underbody covering according to claim 1, wherein the support part (2, 2′, 2″, 2′″, 2″″) is designed in such a way that it forms an essentially closed cavity (16) with the underbody (12) of the motor vehicle in the mounted state.

14. The underbody covering according to claim 1, wherein the support part (2, 2′, 2″, 2′″, 2″″) is shaped in such a way that, in the mounted state of the underbody covering (1, 1′, 1″, 1′″, 1″″), its microperforated, heat-shielding layer (14) and/or its sound-absorbing part (3), whose top is exposed, are each at a distance to the underbody (12) of the motor vehicle.

15. The underbody covering according to claim 1, wherein at least one opening (17), which is used for cooling airflow against an exhaust train section (13) or another heat-releasing vehicle assembly, is implemented on the support part (2″′).

16. The underbody covering according to claim 15, wherein at least one air channel (18) is implemented on the support part (2″′).

17. The underbody covering according to claim 1, wherein the sound-absorbing part (3) has hydrophobic and/or oleophobic properties.

18. The underbody covering according to claim 1, wherein the microperforated, heat-shielding layer (14) is clamped, cast in, or extrusion coated around the edge on the support part (2, 2′, 2″, 2′″, 2″″).
